(19) United States
(12) Patent Application Publication
(10) Pub. No.: US 2016/0017247 A1
(43) Pub. Date: Jan. 21, 2016

(54) Gas Production from an Oil Feedstock

(71) Applicant: MAGNEGAS CORPORATION, Tarpon Springs, FL (US)

(72) Inventors: Christopher Lynch, Largo, FL (US); Mike Rodriguez, Safety Harbor, FL (US); Scott Marton, Tarpon Springs, FL (US); Richard Conz, Seminole, FL (US)

(21) Appl. No.: 14/799,080

(22) Filed: Jul. 14, 2015

Related U.S. Application Data
(60) Provisional application No. 62/024,772, filed on Jul. 15, 2014.

(51) Int. Cl. C10L 3/00; B01J 19/08

(52) U.S. Cl. CPC C10L 3/00; B01J 19/088; B01J 2219/0898; B01J 2219/0877; B01J 2219/0809; C10L 2290/04; C10L 2290/38

(57) ABSTRACT

A system for producing a gas includes a pressure vessel containing in its interior a feedstock that is oil-based and at least one set of electrodes in which an electric arc is formed between the electrodes. The system includes a mechanism for exposing the feedstock to a plasma of the electric arc thereby converting at least some of the feedstock into a gas. The gas comprises from 50-60% hydrogen, from 9-16% ethane, from 8-12% carbon monoxide, from 5-12% ethylene, from 3-8% methane, from 2-3% other trace gases, and from 1-2% carbon dioxide (all % Vol/Vol).

### CROSS-REFERENCE TO RELATED APPLICATION

This application claims the benefit of U.S. provisional application No. 62/024,772 filed on Jul. 15, 2014, the disclosure of which is incorporated by reference.

### FIELD

This invention relates to the field of gas production and more particularly to a system, method and apparatus for the production of a gas from an oil feedstock.

### BACKGROUND

It has been demonstrated that, by exposing and/or flowing certain fluids through the plasma of a submerged electric arc, a unique, combustible gas is produced. The composition of the gas is dependent upon the feedstock in use, but the family of gases produced by exposing and/or flowing certain fluids through the plasma of an electric arc are herein referred to as Magnegas®. Various types and sources of feedstock have been used to produce Magnegas®. The resulting gas burns clean and at higher temperatures than gases occurring in nature or gases produced in different ways.

In general, the feedstock is presented into a reaction chamber, in which a submerged electric arc is formed. As the feedstock is exposed to the arc, the arc releases gases from the feedstock which are captured and stored for future uses.

In various systems, different methods have been anticipated to form the arc, control the electrodes, replenish/replacing the electrodes, capture the gas, capture heat produced, etc. Examples of fully operational systems for the production of Magnegas® can be found in U.S. Pat. No. 7,780,924 issued Aug. 24, 2010, U.S. Pat. No. 6,183,604 issued Feb. 6, 2001, U.S. Pat. No. 6,540,966 issued Apr. 1, 2003, U.S. Pat. No. 6,972,118 issued Dec. 6, 2005, U.S. Pat. No. 6,673,322 issued Jan. 6, 2004, U.S. Pat. No. 6,663,752 issued Dec. 16, 2003, U.S. Pat. No. 6,926,872 issued Aug. 9, 2005, and U.S. Pat. No. 8,236,150 issued Aug. 7, 2012, all of which are incorporated by reference.

In many of the systems for generation of Magnegas®, the reactor (or chamber) is filled with the feedstock and then the feedstock is pumped into and/or around the plasma of the arc, producing the gas which is then collected. In examples where the feedstock is oil, for example, used vegetable oils (e.g. oils previously used to cook food), virgin vegetable oil, motor oil, oil from animals, used hydraulic fluids, etc., it has been found that the resulting gas is very useful in the welding and cutting industry. During the production of gas from oils, it has been found that the electrodes wear at a much greater rate than with many prior feedstock materials.

What is needed is a system for creating a unique gas from a feedstock comprising one or more oils.

### SUMMARY

A system for producing a gas including a pressure vessel containing in its interior a feedstock that is oil-based and at least one set of electrodes in which an electric arc is formed between the electrodes. The system includes a mechanism for passing of the feedstock through a plasma of the electric arc formed between electrodes thereby converting at least some of the feedstock into a gas (e.g., a circulation system). The system has a way to controlling the electric arc by, for example, a controller adjusting the position of the electrodes and/or the voltage/current flowing between the electrodes. The system collects the gas (e.g. moves the gas to a storage tank). Optional vents in the electrodes and/or electrode supports provide escape for unwanted reverse pressure, thereby increasing a flow rate of the feedstock and/or the longevity of the electrodes. The system for producing the gas includes a pressure vessel containing in its interior a feedstock that is oil-based and at least one set of electrodes in which an electric arc is formed between the electrodes. The system includes a mechanism for exposing the feedstock to a plasma of the electric arc thereby converting at least some of the feedstock into a gas. The gas comprises from 50-60% hydrogen, from 9-16% ethane, from 8-12% carbon monoxide, from 5-12% ethylene, from 3-8% methane, from 2-3% other trace gases, and from 1-2% carbon dioxide (all percent by volume).

In one embodiment, a system for producing a gas is disclosed including a pressure vessel containing in its interior a feedstock comprising oil and at least one set of electrodes. An electric arc is formed between the electrodes and the feedstock is exposed to a plasma of the electric arc thereby converting at least some of the feedstock into the gas. There is a device for controlling the electric arc, a way to collect the gas, and a way to replenish the feedstock within the pressure vessel.

In another embodiment, a gas produced by passing exposing an oil to a plasma of an electric arc is disclosed including from 50-60% hydrogen by % Vol/Vol, from 9-16% ethane by % Vol/Vol, from 8-12% carbon monoxide by % Vol/Vol, from 5-12% ethylene by % Vol/Vol, from 3-8% methane by % Vol/Vol, and from 1-2% carbon dioxide by % Vol/Vol.

In another embodiment, a method for producing a gas is disclosed including forming an arc between a set of electrodes within a pressure vessel. The arc formed in a feedstock within the vessel and the feedstock comprising oil. The method includes exposing the feedstock to a plasma of the arc thereby converting at least some of the feedstock into the gas and collecting the gas. When needed, the feedstock is replenished with fresh feedstock within the pressure vessel.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a schematic view of an exemplary system for producing gas.

FIG. 2 illustrates a second schematic view of an exemplary system for producing gas.

FIG. 3 illustrates a schematic view of an exemplary system for producing gas using a closed arc chamber.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

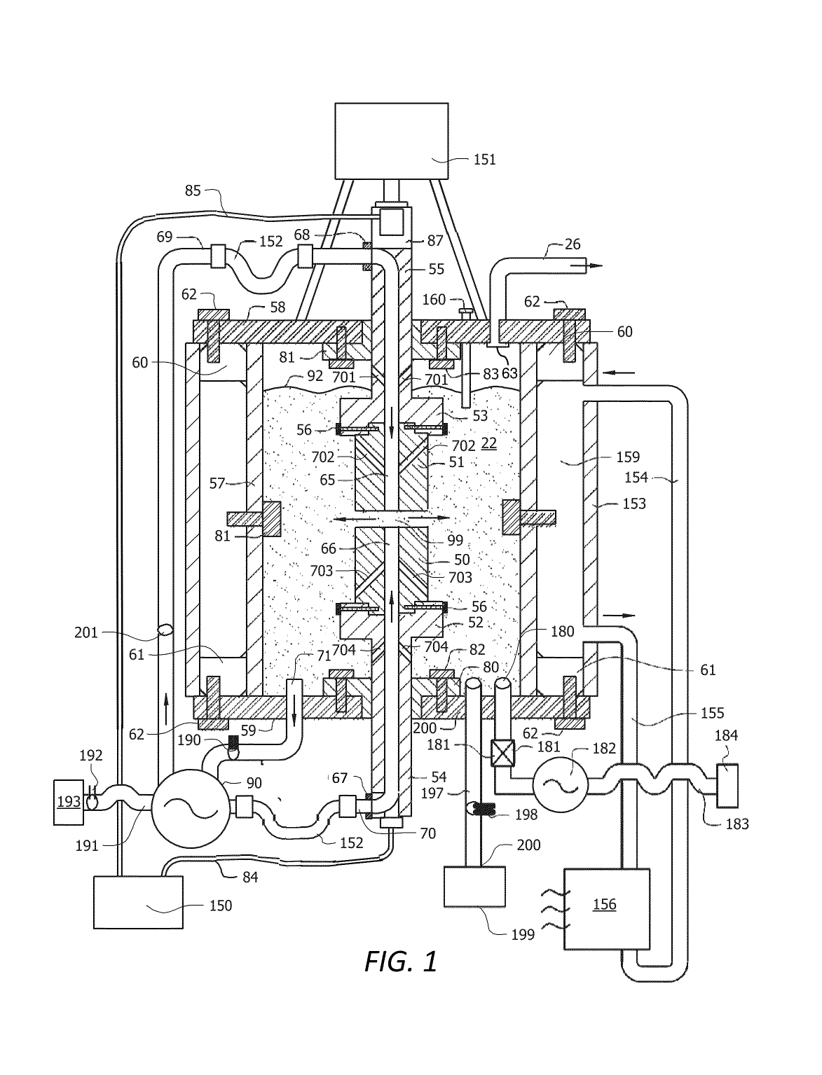

Referring to FIG. 1, an exemplary system for converting a feedstock 22 (liquid) into a gas 24 that is combustible is shown. It is anticipated that, the feedstock 22 is oil, a mixture of oils, or oils and other materials, for example, new motor oil, used motor oil, virgin vegetable oil, used cooking oil, animal fat, crude oil, etc. It is anticipated that some solids are also present in the liquid such as vegetable seeds, sand, metal fragments as in the used motor oil, etc.

The exemplary reactor of FIG. 1 comprises an outer enclosure 57 made of, for example, standard, schedule, carbon steel pipe. Hollow flanges 60/61, are welded to the outer enclosure 57 at each extremity via welding procedures that assure operation at the operating pressure (e.g. 300 psi). Two plain flanges 58/59 (e.g. standard, schedule carbon steel flanges) are fastened to hollow flanges 60/61, with bolts 62 or other fastener sealing the ends of the outer case.

Electrodes 50/51 housed in the interior of the outer enclosure 57. The electrodes 50/51 are preferably made of the standard graphite composition, such as commercially available for arc furnaces. The electrodes 50/51 are retained by conducting metal holders 52/53 and held to the conducting metal holders 52/53 by fasteners 56. The conducting metal holders 52/53 connect or continue into conducting metal shafts 54/55. The conducting metal shafts 54/55 pass through the plain flanges 58/59, insulated by insulated bushings 80/81. In some embodiments, the insulated bushings 80/81 are made of phenolic or an equivalent insulating, temperature and pressure resistant material. The insulated bushings 80/81 are fastened to the plain flanges 58/59 by bolts 82/83 (or equivalent attachment devices).

At least one or both of the conducting metal shafts 54/55 are disposed to move along their axial symmetry. The conducting metal shafts 54/55 are connected via cables 84/85 to an electric power source 150. For example, the axial displacement of conducting metal shaft 55 is performed by an actuator 151 (e.g., an actuator or other similar device). The actuator 151 initiates, maintains and optimizes the submerged electric arc in the gap 99 between the electrodes 50/51. Axial displacement of the conducting metal shaft 55 is allowed by cables 84/85 (preferably flexible cables) and flexible feed hoses 152. The flexible feed hoses 152 and related flanges 67/68 are fed with the feedstock 22 by a circulation pump 90.

In a preferred embodiment, the electric power source 150 consists of either an AC to DC converter or a three phase AC power source. In some embodiments, the electric power source 150 has a variable output voltage (e.g. up to 1,000V) and/or a variable output frequency (e.g. 0 to 10,000 Hz).

The fill-level 92 of the feedstock 22 is monitored by a sensor/probe 160 or other device for monitoring a fill-level 92 of the feedstock 22 within the outer enclosure 57.

Heat reduction/recovery/control is performed. Heat needs to be removed/recovered/controlled to prevent run-away temperature conditions. Although not required, it is advantageous to recover the heat and use the heat for useful purposes such as generating electricity or pre-heating of fresh feedstock 22. In some embodiments, heat is captured with the use of an outer case 153 that is welded to the hollow flanges 60/61 so as also to withstand the operating pressure (e.g. a pressure of 300 psi). The volume between the outer enclosure 57 and outer case 153 is filled with a heat transfer liquid 159 suitable for the recovery of the heat produced in the interior of the vessel. At least one input port and pipe 154 provides for the flow of the heat transfer liquid 159 into the volume between the outer enclosure 57 and outer case 153 and at least one exit port and related pipe 155 provides for the exit of the heat transfer liquid 159. The pipes 154/155 are connected to a heat recovery system 156 such as a turbine run electric generator (not shown) or other industrially available device for the production of electric current. Electric current is generated in any way known through the use of heat absorbed by the heat transfer liquid 159 when the heat transfer liquid is between the outer enclosure 57 and outer case 153. For example, the heat is used to generate steam and the steam turns a turbine that is interfaced to an electric generator or the heat is converted to electricity by a fuel cell, etc.

In some modes of operation, the feedstock 22 enters through a pipe 180 that passes through the flange 59, passing through check valve 181 from an input pump 182, from another pipe 183 to from a source tank 184 that contains the feedstock 22. The Reactor is, preferably, automatically refilled from the source tank 184 under electronic control whenever sensor/probe 160 detects the decrease of the fill-level 92 of the feedstock 22 below the allowed value by the circulation pump 90.

In some modes of operation, the feedstock 22, for example, from an oil storage tank 193, enters through a pipe 191 through an input valve 192 directly into the circulation pump 90. This enables, for example, a one-pass routing of the feedstock 22 from the oil storage tank 193, through the circulation pump 90, through the arc/gap 99 and out one of the exit tube 197.

After sufficient gas production, the feedstock 22 flows out through an output port 200 in the flange 59 through an exit tube 197 under control of an exit valve 198 into, for example, a storage tank 199.

The electrodes 50/51 include axial bores 65/66. The axial bores 65/66, continue along the axial symmetry of conducting metal holders 52/53 and conducting metal shafts 54/55 and connect exterior of the apparatus to circulation input pipes 69/70 by flanges 67/68. The circulation input pipes 69/70 are connected to a circulation pump 90 that continually circulates the feedstock 22 through the axial bores 65/66 and into the gap 99.

As, for example, some of the produced combustible gases are ignited by the arc between the electrodes 50/51, back pressure waves occur, pushing the feedstock 22 in a reverse direction into the axial bores 65/66 and causing, for example, foaming of feedstocks 22 (e.g., some feedstocks 22 foam). This disrupts the flow of the feedstock 22, wears the electrodes 50/51, and reduces efficiency. In some embodiments, to reduce, for example, the back pressure caused by the combustion of the combustible gases, one or more vents 702/703 are drilled or formed in the electrodes 50/51, one or more vents 701/704 are drilled or formed in the conducting metal holders 52/53, or in both the electrodes 50/51 and the conducting metal holders 52/53. The vents 701/702/703/704 are drilled or formed at an angle with respect to the axis of the electrodes 50/51 and/or the conducting metal holders 52/53, reducing parasitic outflow while facilitating escape of feedstock 22 that reverses flow under, for example, back flash pressure. Although there is no restriction on the angle, it is preferred that the vents 701/702/703/704 angle towards the flow of the feedstock 22 within the electrodes 50/51 and/or the conducting metal holders 52/53. In other words, the preferred angle of the vent(s) is such that, during the normal flow of the feedstock 22 through the electrodes 50/51 and the conducting metal holders 52/53, some amounts of the feedstock 22 exits the vents 701/702/703/704 or, for some angles, feedstock 22 is drawn in through the vents 701/702/703/704. When back flow occurs, forces temporary reverses the flow of the feedstock 22 (e.g., back into the electrodes 50/51). Since the vents 701/702/703/704 are preferably angled towards the gap 99 (e.g. location of the arc), the feedstock 22 flowing in this reverse direction exits the vents 701/702/703/704, reducing the back pressure.

Any number of vents 701/702/703/704 is anticipated, including one vent 701/702/703/704.

The exemplary apparatus is further equipped with a circulation drain 71 to exit the feedstock 22 through an exit pipe 91 to the circulation pump 90 for continued recirculation under control of a circulation valve 190.

A gas collection pipe 26 is connected to the plain flange 58 at the top releasing the gas 24 for collection and use. The collected gas is contained, used, and/or compressed in ways known in the industry.

The operation of this embodiment of the reactor includes three modes of operation depending upon the type of feedstock 22 being processed: Gasification, Sterilization, and Batch. Gasification is a preferred mode for feedstocks 22 that are oil-based such as used engine oil, used cooking oil, oil contaminated by salt water, animal-based oils, crude oils, used hydraulic fluids, etc., typically running closed-loop until additional feedstock 22 is required. Sterilization is typical for sewerage, having an internal loop that operates at approximately six-times the input/output flow rate of the system, and Batch is typical for contaminated water such as in the production of reclaimed water, running until a specific temperature is achieved.

The feedstock 22 starts in the oil storage tank 193. In Gasification, it is desired to produce a gas 24 from the feedstock 22 (e.g., oil). The feedstock 22 is continuously circulated through the arc and generates the gas 24 that is released through a port 63. During the process, heat is optionally captured and utilized by the heat recovery system 156 and a small percentage of inert solid residues are deposited at the bottom of the apparatus for periodical collection.

In Gasification, the feedstock 22 is pumped from a source tank 184 into the apparatus to the fill-level 92. Additional feedstock 22 is pumped from the source tank 184 into the apparatus when the sensor/probe 160 determines that the liquid (feedstock) level falls below the fill-level 92. In Gasification, the input valve 192 and the exit valve 198 are closed and the circulation valves 190/201 are open. The circulation pump 90 continuously circulates the feedstock 22 through the electric arc in the gap 99 between electrodes 50/51. The feedstock 22 and the gas 24 that is produced exits the gap 99, avoiding ignition/recombination of the gas 24 caused by the arc/plasma. This operation and internal pressure produces a large amount of heat that is optionally converted into electricity (or other uses) by the heat recovery system 156.

In Sterilization mode, it is not economically advantageous to convert all of the feedstock 22 to the gas 24. The goal is to neutralize all or most of the biological contaminants (a portion of the feedstock 22 is biological contaminants, e.g. 10%). In Sterilization mode, the circulation valves 190/201 and the input valve 192 are open and the exit valve 198 is closed. In this case, the feedstock 22 is continuously pumped into the apparatus from the source tank 184 by the input pump 182. The input pump 182 operates at a moderate rate, pumping a moderate number of gallons per minutes (e.g., at 20 gpm corresponding to 1,200 gallons per hour) while the circulation pump 90 is operated at maximal flow (e.g., 100 gpm) producing maximum arc stability. After exposure to the arc, sterilized liquid wastes exits through the exit tube 197 to the storage tank 199 while the gas 24 is expelled at a controlled pressure through the port 63. The feedstock 22 flows through the arc several times before being expelled to the storage tank 199. For instance, using an example value of 20 gpm for input pump 182 and 100 gpm for the circulation pump 90, the liquid waste flows through the arc (on average) five times before being expelled to the storage tank 199, thus allowing the sterilization of highly infectious liquids. The flow of the feedstock 22 through the gap 99 of the electrodes produced the gas 24.

In Batch mode, the feedstock 22 is passed through the arc one time, sufficient for sterilization, and then the sterilized liquid waste is released to the outside of the apparatus. For example, the released, sterilized liquid waste is treated by conventional water deputation equipment as known to those skilled in the art. In Linear mode, the circulation valves 190/201, the input valve 192 and the exit valve 198 are open. Feedstock 22 from the oil storage tank 193 is pumped through the arc by the circulation pump 90. A sterilized form of the feedstock 22 exits through the output port 200 to the storage tank 199 by way of pressure of the gas inside the vessel (e.g. without any need of pumps). The exit valve 198 is adjusted to maintain the fill-level 92 of the feedstock 22 for the selected flow of incoming feedstock 22. Again, the entirety of the feedstock 22 is passed through the arc along with the creation of the gas 24.

The electric power source 150 is, for example, an AC-DC welder; a high voltage DC current source; a pulsed DC current source, pulsating at a frequency which is a sub-multiple of a resonating frequency of the selected liquid; a pules DC signal modulated onto a DC voltage; an AC welder; an AC source with variable high voltage and high frequency; an AC source with variable frequency which is a sub-multiple of the resonating frequency of the selected liquid; or other commercially available sources of electricity suitable to create a submerged electric arc.

For the sterilization of highly biologically contaminated liquid (feedstock), the use of the DC welder is preferred. When the goal is production of the gas 24, a Pulsating DC source or high frequency AC source is preferred. The latter sources are preferred to have variable frequencies because different feedstocks 22 have different resonating frequencies. In some cases, the voltage and/or frequency is varied until achieving a maximum production of the gas 24.

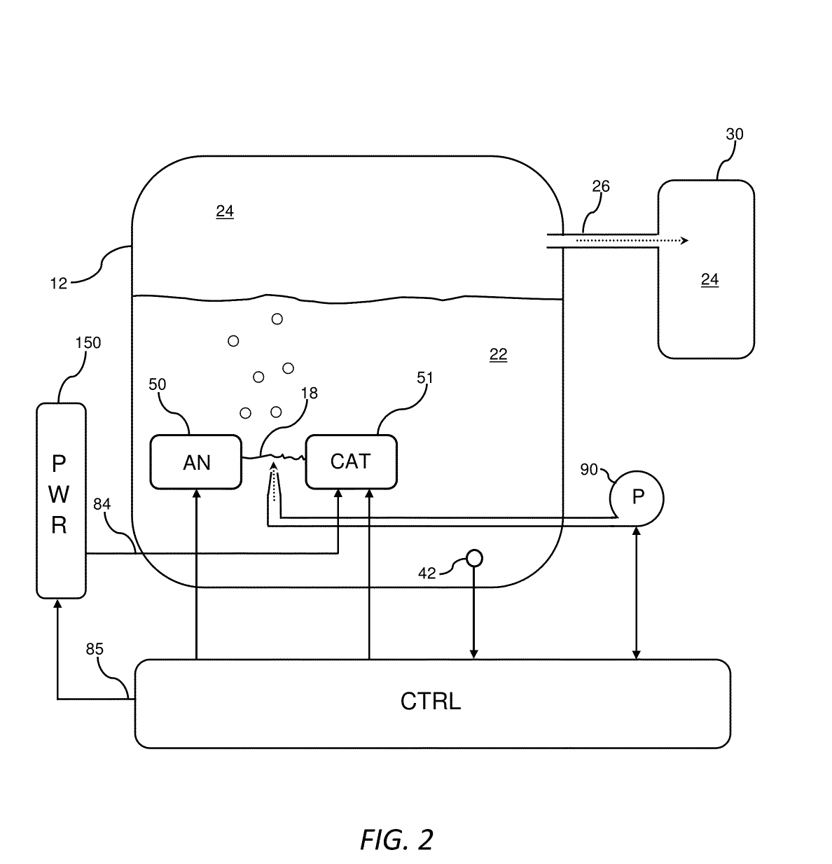

Referring to FIG. 2, a simplified, exemplary system for the production of a gas 24 is shown. The gas 24 is typically in gaseous form as used herein, though a conversion to liquid form is fully anticipated. This is but an example of one system for the production of a gas 24, as other such systems are also anticipated as shown previously. Examples of other fully operational systems for the production of Magnegas® can be found in U.S. Pat. No. 7,780,924 issued Aug. 24, 2010, U.S. Pat. No. 6,183,604 issued Feb. 6, 2001, U.S. Pat. No. 6,540,966 issued Apr. 1, 2003, U.S. Pat. No. 6,972,118 issued Dec. 6, 2005, U.S. Pat. No. 6,673,322 issued Jan. 6, 2004, U.S. Pat. No. 6,663,752 issued Dec. 16, 2003, U.S. Pat. No. 6,926,872 issued Aug. 9, 2005, and U.S. Pat. No. 8,236,150 issued Aug. 7, 2012, all of which are incorporated by reference.

As exemplified in FIG. 2, the production of such a gas 24 is performed within the plasma of an arc 18 submerged within the feedstock 22. The arc 18 is formed by providing an electrical potential between an anode 50 of the electrodes 50/51 and a cathode 51 of the electrodes 50/51 that are of sufficient proximity to each other as to allow arcing between the anode 50 of the electrodes 50/51 and the cathode 51 of the electrodes 50/51. An electric power source 150 provides sufficient power (voltage and current) as to initiate and maintain the arc.

A feedstock 22 is circulated within a reactor 12 by, for example, a circulation pump 90 and the feedstock 22 is injected into the plasma of the arc 18 formed between two electrodes 50/51, causing the feedstock 22 to react, depending upon the composition of the feedstock 22 and the composition of the electrodes 50/51 used to create the arc. One exemplary feedstock 22 is oil, and more particularly, used vegetable or animal oil such as that from deep-fat fryers, etc. Of course, any oil is anticipated, including unused vegetable oil, oil from petroleum, and oil from animal fat. Any feedstock 22 is anticipated either in fluid form or a fluid mixed with solids, preferably fine-grain solids such as carbon dust, etc.

In one example, the feedstock 22 is vegetable oil and the electrodes 50/51 are carbon, the vegetable oil molecules separate within the plasma of the arc 18 forming a gas 24, typically including hydrogen, methane, ethane, and carbon monoxide (CO) atoms, which percolate to the surface of the feedstock 22 for collection (e.g. extracted through the gas collection pipe 26) and is stored in a collection tank 30. This gas 24 has similarities to natural gas and/or syngas. In embodiments in which at least one of the electrodes 50/51 that form the arc 18 is made from carbon, such electrode(s) 50/51 serve as a source of charged carbon particles that become suspended within the gas 24 and are collected along with the gas 24, thereby changing the burning properties of the resulting gas 24.

In examples in which the feedstock 22 is a petroleum-based liquid, the exposure of this feedstock 22 (petroleum-based) to the plasma of the arc 18 results in production of a gas that includes polycyclic aromatic hydrocarbons which, in some embodiments, are not stable and, therefore, some of the polycyclic aromatic hydrocarbons will form/join to become a liquid or gas. Therefore, some polycyclic aromatic hydrocarbons as well as some carbon particles are present in the resulting gas 24. In some embodiments, some of the carbon particles are trapped or enclosed in poly cyclic bonds. Analysis of the gas 24 that is produced typically shows inclusion of polycyclic aromatic hydrocarbons that range from C6 to C14. The presence of polycyclic aromatic hydrocarbons as well as carbon particles contributes to the unique burn properties of the resulting gas 24.

In another example, when the feedstock 22 is petroleum based (e.g. used motor oil) and at least one of the electrodes 50/51 is/are carbon, the petroleum molecules separate within the plasma of the arc 18 into a gas 24 that includes hydrogen and aromatic hydrocarbons, which percolate to the surface of the feedstock 22 (petroleum liquid) for collection (e.g. extracted through the gas collection pipe 26) and stored in a collection tank 30. In some embodiments, the gas 24 produced though this process includes suspended carbon particles since at least one of the electrodes 50/51 is made from carbon and serves as the source for the charged carbon particles that travel with the manufactured hydrogen and aromatic hydrocarbon in the gas 24 and are collected along with, for example, the hydrogen and aromatic hydrocarbon molecules, thereby changing the burning properties of the gas 24, leading to a hotter flame. In some examples, the feedstock 22 is oil (e.g. used cooking oil) and the fluid/gas 24 collected includes any or all of the following: hydrogen, ethylene, ethane, methane, and other combustible gases to a lesser extent, plus suspended charged carbon particles that travel with these gases.

The resulting gas is stored in, for example, a collection tank 30 and moved/distributed as known in the gaseous/liquid fuel industry.

In the example shown in FIG. 1, a circulation pump 90 runs continuously, flowing the feedstock 22 through the plasma of the arc 18 formed between the electrodes 50/51. In such, manual or automatic adjustment of the arc, power to the electrodes, and refilling of the feedstock are periodically performed.

It has been found that operation of an arc between two electrodes 50/51 (typically made of carbon) in a feedstock 22 that is oil-based results in a relatively quick consumption of the electrodes 50/51. In some embodiments, two different technologies are used to reduce the rate of consumption of the electrodes 50/51. The first technology that improves wear of the electrodes 50/51 is vents 701/702/703/704, as described above with FIG. 1. The vents 701/702/703/704, provide fresh feedstock to the arc 18 for input vents 701/702/703/704 (flow towards the arc 18) and allow for venting of the gas in exit vents 701/702/703/704 (flow away from the arc 18). As in the previous description with FIG. 1, it is anticipated that one or both electrodes be physically positioned by, for example, an actuator 151 or manual device, such that, as the electrodes 50/51 wear, the actuator 151 compensates for the wear by continuously adjusting the gap.

It has been found that the gas 24 produced from feedstocks containing or entirely of oil perform well in various applications such as welding and/or cutting of metals. The resulting gas 24 comprises from 50-60% hydrogen, from 9-16% ethane, from 8-12% carbon monoxide, from 5-12% ethylene, from 3-8% methane, from 2-3% other trace gases, and from 1-2% carbon dioxide (all percent by volume).

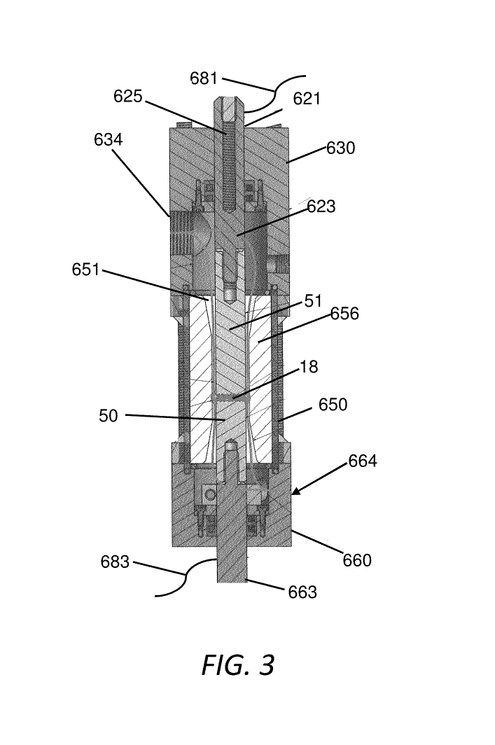

It has also been found that, due to the high hydrocarbon content of feedstock 22 containing oil, after a short operation of the reactor 12/57, there is significant buildup of carbon deposits on either the anode 50 and/or a cathode 51 (e.g., depending upon flow direction), limiting the continuous operation of reactors 12/57. To greatly reduce the buildup of carbon deposits, a reactor having the anode 50 and a cathode 51 within a venturi is used, as shown in FIG. 3. The arc 18 is formed between two electrodes 50/51. The cathode 51 is held in a preferably non-conductive cathode housing 630 and connected to power through, for example, a connection block 623. The anode 50 is held in a second, preferably non-conductive anode housing 660. Power is connected to the anode 50, for example, at a connection point to the anode shaft 663. In a preferred embodiment, the cathode 51 is made from carbon or a carbon composition.

Because the anode 50 and, in particular, the cathode 51 erode or accept carbon as a result of the arc 18, and because it is desired to maintain the arc by moving the cathode 51 closer to or farther away from the anode 50, a motorized drive system (not shown) is included in a preferred embodiment, for example, a drive screw interfaced (not shown) to a threaded bore 625 axially within cathode shaft 621. Although there are many known ways to move either the anode 50, the cathode 51, or both, all of which are included here within, for example a screw drive. In some embodiments, the anode shaft 663, and hence, the anode 50 rotate to improve the life of the anode 50.

The arc 18 is formed within a chamber 651 of an insulated sleeve 656. The insulated sleeve 656 is preferably made of ceramic and having a vessel body 650. The insulated sleeve 656 is, for example, generally tubular and, in some embodiments, tapered to form a venturi (as shown).

In some embodiments, the insulated sleeve 656 is enclosed in a vessel body 650, preferably made of metal such as steel. The vessel body 650 contains the pressure that is present within the chamber 651.

Oil 22 is pumped though the insulated sleeve 656 for exposure to the arc 18, during which the arc 18 is energized by applying appropriate power to the cathode 51 and anode 50 through a connection 681 to the cathode shaft 621 and a connection 683 the anode shaft 663.

Oil 22 flows, preferably under pressure, into the non-conductive anode housing 660 through an inlet port 664. The oil 22 flows through the chamber 651 within the insulated sleeve 656 where the oil 22 is exposed to the arc 18 for generation of the gas 24. Finally, the oil 22 and gas flow through the non-conductive cathode housing 630 and out of an outlet port 634. Note that flow of oil 22 in either direction is anticipated. In some embodiments, some or all of the oil 22 is recirculated along this same path for further exposure to the arc 18 and further generating of the gas 24.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A system for producing a gas, the system comprising:
a pressure vessel containing in its interior a feedstock comprising oil and at least one set of electrodes;
an electric arc formed between the electrodes;
means for exposing the feedstock to a plasma of the electric arc thereby converting at least some of the feedstock into the gas;
means for controlling the electric arc;
means for collecting the gas; and
means for replenishing the feedstock within the pressure vessel.

2. The system for producing the gas of claim 1, wherein the oil is vegetable oil.

3. The system for producing the gas of claim 1, wherein the oil is animal oil.

4. The system for producing the gas of claim 1, wherein the oil is used vegetable oil.

5. The system for producing the gas of claim 1, wherein the oil is used animal oil.

6. The system for producing the gas of claim 1, wherein the oil is petroleum-based oil.

7. The system for producing the gas of claim 1, wherein the oil is used petroleum-based oil.

8. The system for producing the gas of claim 1, wherein the oil is used motor oil.

9. The system for producing the gas of claim 1, wherein the gas comprises:
from 50-60% hydrogen by % Vol/Vol;
from 9-16% ethane by % Vol/Vol;
from 8-12% carbon monoxide by % Vol/Vol;
from 5-12% ethylene by % Vol/Vol,
from 3-8% methane by % Vol/Vol; and
from 1-2% carbon dioxide by % Vol/Vol.

10. A gas produced by passing exposing an oil to a plasma of an electric arc, the gas comprising:
from 50-60% hydrogen by % Vol/Vol;
from 9-16% ethane by % Vol/Vol;
from 8-12% carbon monoxide by % Vol/Vol;
from 5-12% ethylene by % Vol/Vol;
from 3-8% methane by % Vol/Vol; and
from 1-2% carbon dioxide by % Vol/Vol.

11. The gas produced by passing exposing the oil to the plasma of the electric arc of claim 10, the gas further comprising from 2% to 3% of trace gases.

12. The gas produced by passing exposing the oil to the plasma of the electric arc of claim 10, wherein the oil is vegetable oil.

13. The gas produced by passing exposing the oil to the plasma of the electric arc of claim 10, wherein the oil is animal oil.

14. The gas produced by passing exposing the oil to the plasma of the electric arc of claim 10, wherein the oil is petroleum-based oil.

15. The gas produced by passing exposing the oil to the plasma of the electric arc of claim 10, wherein the oil is used motor oil.

16. A method for producing a gas, the method comprising:
forming an arc between a set of electrodes within a pressure vessel, the arc formed in a feedstock within the vessel, the feedstock comprising oil;
exposing the feedstock to a plasma of the arc thereby converting at least some of the feedstock into the gas;
collecting the gas; and
when needed, replenishing the feedstock within the pressure vessel.

17. The system for producing the gas of claim 1, wherein the gas comprises:
from 50-60% hydrogen by % Vol/Vol;
from 9-16% ethane by % Vol/Vol;
from 8-12% carbon monoxide by % Vol/Vol;
from 5-12% ethylene by % Vol/Vol,
from 3-8% methane by % Vol/Vol; and
from 1-2% carbon dioxide by % Vol/Vol.

18. The method for producing the gas of claim 16, wherein the oil is vegetable oil.

19. The method for producing the gas of claim 16, wherein the oil is animal oil.

20. The method for producing the gas of claim 16, wherein the oil is petroleum-based oil.
